(19) United States
(12) Patent Application Publication
(10) Pub. No.: US 2013/0152980 A1
(43) Pub. Date: Jun. 20, 2013

(54) Apparatus, Process, and System for Cleaning Paint Roller Covers

(71) Applicant: Peter James HUES, San Diego, CA (US)

(72) Inventor: Peter James HUES, San Diego, CA (US)

(21) Appl. No.: 13/327,742

(22) Filed: Dec. 15, 2011

(51) Int. Cl. B08B 3/02

(52) U.S. Cl. 134/36; 134/198; 134/172; 134/151; 134/113; 134/178; 134/38

(57) ABSTRACT

Apparatuses, systems, and methods to clean a paint roller are disclosed. Such apparatuses and systems include a housing with an outlet; a handle connected to housing; an adapter disposed on an end portion of the handle; a nozzle disposed inside the handle; an idler attached to an inside surface of the housing; and a slot disposed on the housing on a location substantially opposite to the location of the inside surface of the housing where the idler is attached, wherein the idler is configured to support a paint roller cover to be cleaned and the slot is configured to receive a first portion of a paint roller frame configured to support the paint roller cover so as to dispose the paint roller cover substantially in front of the cleaning fluid jet.

### BACKGROUND

1. Technical Field

Embodiments of the subject matter disclosed herein relate generally to apparatuses, methods and systems and, more particularly, to mechanisms and techniques for cleaning paint roller covers.

2. Discussion of the Background

One conventional way to apply paint to a surface is to use a roller brush or paint roller cover in combination with a support frame that allows the roller soaked with paint to spread paint by rolling over the surface to be painted. Professional painters and do-it-yourself individuals alike may prefer this method over other more sophisticated approaches, such as painting with a paint sprayer, due at least in part to the fact that paint sprayers are substantially more expensive and may also require substantially more preparation, particularly when repainting a finished space. Nevertheless, handling a used roller brush or paint roller cover remains a challenge since it is either disposed after a single use or a significant cleaning effort must be spent before the roller brush is ready to be used again.

A large number of U.S. Utility and Design Patents have been granted to devices designed to clean used paint roller covers (see, for example, the U.S. utility Pat. Nos. 7,806,129, 7,325,556, 7,229,206, 6,408,862, 6,116,255, 6,079,429, 5,935,342, 5,932,028, 5,816,275, 5,505,220, 5,487,399, 5,452,734, 5,413,133, 5,402,808, 5,337,769, 5,322,081, 5,238,012, 5,185,938, 5,184,637, 5,095,928, 4,809,722, 4,765,354, 4,735,221, 4,733,679, 4,708,152, 4,700,728, 4,672,987, 4,667,361, 4,641,673, 4,606,777, 4,508,465, 4,446,590, 4,402,333, 4,311,158, 4,294,272, 4,155,230, 4,130,124, 4,126,484, 4,108,189, 3,886,960, 3,577,280, 3,428,060, 2,219,732, and 2,072,001; or the U.S. design patents of numbers: D615,720, D576,772, D511,600, D457,697, D357,775, D340,327, D330,101, D267,123, and D265,940, the contents of all of these patents are incorporated herein by reference in their entirety). In addition, recently, several Patent Applications have been published dealing also with devices to clean paint roller covers, such as U.S. Patent Publication Applications of numbers 20100252077, 20090084419, 20080047084, 20060064836, 20060016464, 20050247329, 20050018533, and 20030053838, the contents of all of these patent application publications are also incorporated herein by reference in their entirety.

The interest in devices to clean paint roller covers is clearly understood by those of ordinary skill since it generally takes less time to clean a paint roller cover, cleaning by hand is not an attractive solution, and re-using paint roller covers is a more effective approach rather than simply discarding them, resulting in additional cost with the purchase of new ones as well as unnecessarily increasing the use of landfills. Nevertheless, a review of the devices disclosed in the above-summarized documents as well as of other commercially available paint roller cover cleaners clearly identifies several problems with these conventional approaches. These problems include, but are not limited to, ineffectiveness or incompleteness of the cleaning process, unwieldy operation, high cost, large size, the requirement that the cleaning be performed outdoors, lack of durability, the requirement for the use of electricity, difficulty in handling discharged cleaning fluids, the requirement that a user needs to touch the paint roller covers early in the cleaning process, and the fact that the cleaning process is uncontained and messy, just to name a few.

Accordingly, it would be desirable to provide apparatuses, methods, and systems for cleaning paint roller covers that will reduce or eliminate the afore-described problems and drawbacks as well as others appreciated by those of ordinary skill after consideration of the subject matter disclosed.

### SUMMARY

According to one exemplary embodiment, an apparatus configured to clean a paint roller is described. This apparatus includes a housing having an outlet; an adapter disposed on an end portion of the housing, a nozzle disposed inside the housing; an idler attached to an inside surface of the housing; and a slot disposed on the housing, wherein the idler is configured to support a paint roller cover to be cleaned and the slot is configured to receive a first portion of a paint roller frame configured to support the paint roller cover so as to dispose the paint roller cover substantially in front of the cleaning fluid jet.

According to another embodiment, a paint roller cleaner is disclosed that includes a housing having an outlet; a handle connected to the housing; an adapter disposed on an end portion of the handle; a nozzle disposed inside the handle; a lever connected to the nozzle, the lever being configured to change a position of the cleaning fluid jet; an idler attached to an inside surface of the housing; a valve disposed on the handle; a clamp disposed on an outside surface of the housing, the clamp being configured to hold a first portion of a paint roller frame configured to support the paint roller cover; and a slot disposed on the housing on a location substantially opposite to the location of the inside surface of the housing where the idler is attached, wherein the idler is configured to support a paint roller cover to be cleaned, and the slot is configured to receive a second portion of the paint roller frame of the paint roller so as to dispose the paint roller cover substantially in front of the cleaning fluid jet.

A method of cleaning a paint roller is also within the subject matter disclosed herein. Such method including the steps of providing a housing having an outlet; connecting a handle to the housing; disposing an adapter on an end portion of the handle; disposing a nozzle inside the handle; attaching an idler to an inside surface of the housing; and disposing a slot on the housing on a location substantially opposite to the location of the inside surface of the housing where the idler is attached, wherein the idler is configured to support a paint roller cover to be cleaned, and the slot is configured to receive a first portion of a paint roller frame configured to support the paint roller so as to dispose the paint roller cover substantially in front of the cleaning fluid jet.

### BRIEF DESCRIPTION OF THE DRAWINGS

In order to facilitate the understanding of the various disclosed embodiments, their description and associated explanation will be provided with reference to the specific exemplary embodiments illustrated in the appended drawings or figures (not drawn to scale), which are incorporated in and constitute a part of the specification, illustrate one or more embodiments and, together with the description, explain these embodiments, wherein:

FIG. 1 illustrates a paint roller cleaner according to an embodiment of the subject matter disclosed;

FIG. 2 illustrates the paint roller cleaner of FIG. 1 charged with a paint roller;

FIG. 3 illustrates a paint roller cleaner according to another embodiment of the subject matter disclosed;

FIG. 4 illustrates the paint roller cleaner of FIG. 3 charged with a paint roller;

FIG. 5 illustrates an exploded view of the paint roller cleaner of FIG. 3;

FIG. 6 illustrates a side view along line 6-6 in FIG. 3;

FIG. 7 illustrates a side view along line 7-7 in FIG. 3;

FIG. 8 illustrates a side view along line 8-8 in FIG. 7;

FIG. 9 illustrates a paint roller cleaner in an open position with a paint roller disposed therein according to another embodiment of the subject matter disclosed;

FIG. 10 illustrates the paint roller cleaner of FIG. 9 in a closed position;

FIG. 11 illustrates an exploded view of the paint roller cleaner of FIG. 9;

FIG. 12 illustrates a paint roller cleaner according to another embodiment of the subject matter disclosed; and

FIG. 13 illustrates a flowchart for a method of cleaning a paint roller cover.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of apparatuses, systems, or methods capable of cleaning paint roller covers mounted to a paint roller frame. However, the embodiments to be discussed next are not limited to these sets, but may be applied to other types of paint rollers to be cleaned after use.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Generally speaking, the paint roller cleaning devices disclosed herein include a housing to which a paint roller cover disposed on a paint roller frame can be mounted to and cleaned easily by a user handling the device. Depending on a user preference, such a cleaning might be accomplished with a single hand. A cleaning fluid, for example water, is provided to the housing under pressure and directed to the paint roller cover causing the same to spin while it is being cleaned. The cleaning fluid is then discharged from the housing through a housing outlet in such a fashion so as to prevent a messy discharge.

As it will be appreciated by those of ordinary skill based on the subject matter disclosed herein, such devices provide several advantageous features when compared to other conventional counterparts. These advantages include, but are not limited to, effectiveness and/or completeness of the cleaning process, manageable operation, low cost, small size, the cleaning may be performed indoors or outdoors, durability, no electricity required, easiness of handling discharged cleaning fluids, no need to touch the paint roller covers early (or potentially ever) in the cleaning process, the fact that the cleaning process is contained and orderly, and the fact that their compact assembly require less shelf space at retail stores. In one embodiment, additional control of the cleaning process is provided by a lever-actuated adjustable spray nozzle that can be directed so as to cause the cleaning fluid to efficiently impinge upon the paint roller cover along a near-tangent line or any other preferred location. And, in yet another embodiment, an auxiliary spray nozzle is used to better clean the ends of the paint roller cover. In another embodiment, the paint roller can be loaded into the cleaning device either vertically or horizontally with one end thereof supported by the roller frame wire and with the other end supported by an idler that allows the paint roller to spin as the cleaning process takes place while, at the same time, leaving the majority of the roller cover unobstructed and accessible to the cleaning liquid spray or jet.

In another embodiment, the cleaning housing includes two portions connected by a hinge that can be closed by a snap closure in order to better contain the discharge of the cleaning fluids. The first portion of the housing includes the valve, the spray nozzle, the idler, a clamp to hold the paint roller frame attached to the housing while the paint roller cover is being cleaned, and the valve that controls the cleaning liquid flow being separate from the spray nozzle, while the second portion of the housing comprises a streamlined exhaust port for better handling the discharge of the cleaning fluid and improved overall appearance of the cleaning device. In another embodiment, a window is provided so as to allow the user better monitoring capability of the cleaning process and yet in another embodiment the housing may be transparent. In yet another embodiment, the housing includes a snap that is hinged with a break-away, a branding label surface, and a custom valve without threads so as to simplify tooling, to improve valve assembly, and to improve valve lever appearance. The outlet may also be widened for improved roller speed and cleaning fluid penetration depth and an improved roller frame snap clamp may be provided so as to reduce tooling complexity and to facilitate use of these advantageous devices. A better understanding of these advantages, and others, will become more apparent with the following detailed description of various exemplary embodiments

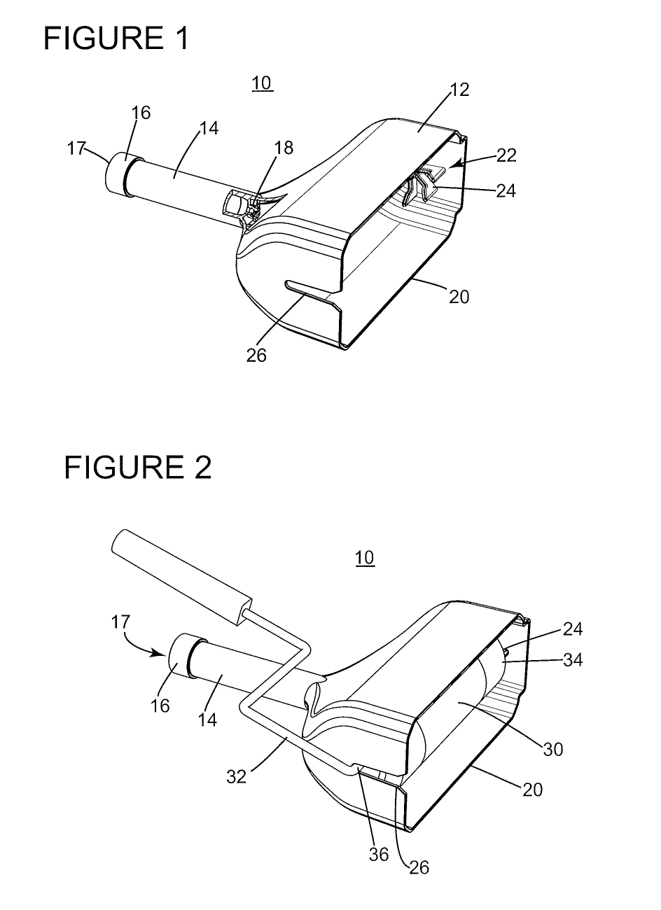

FIG. 1 illustrates a paint roller cleaner 10 according to an embodiment of the subject matter disclosed. As shown, in this embodiment, the paint roller cleaner 10 includes a housing 12 having a handle 14 attached thereto. At an end portion of the handle 14, an adapter 16 is provided at an inlet 17, the adapter 16 being configured to connect the paint roller cleaner 10 to a supply of cleaning fluid under pressure. Examples of attachments to the adapter 16 may include, but are not limited to, a garden hose thread, or GHT; a national pipe thread, or NPT, with a gasket or alternate sealing method; straight threads with a gasket or alternate sealing method; a hose barb with or without a hose clamp; and a quick-disconnect fitting. In some embodiments the adapter 16 may be an integral part of the housing 12. In other embodiments, the handle 14 may be an integral part of the housing 12.

Also provided in the handle 14 is a nozzle 18 (illustrated in the cutaway portion of FIG. 1) to increase the velocity and to control the spray pattern of the cleaning fluid during the cleaning process. At the other end portion of the paint roller cleaner 10, the housing 12 has an outlet 20 through which the used cleaning fluid is discharged from the paint roller cleaner 10. As also illustrated in FIG. 1, on an inside surface 22 of the housing 12 an idler 24 is provided so as to facilitate the rotation of a paint roller cover during the cleaning process and/or to constrain the position of a paint roller cover within paint roller cleaner 10. Alternately, in another embodiment, the idler 24 may be replaced with one or more rollers with forces acting normal to one of the faces of the roller cover, a clamp configured to cantilever a paint roller frame during cleaning without the requirement of any secondary support, or a system that requires the user to hold the paint roller frame in place during cleaning, thereby eliminating the need for secondary roller frame support. On a side opposite to that of the idler 24, the housing 12 includes a slot 26 configured to accommodate a portion of a paint roller wire frame (not shown in FIG. 1) holding a paint roller cover to be cleaned in the paint roller cleaner 10.

In use, as shown in FIG. 2, a paint roller cover (or roller cover) 30 mounted to a paint roller frame 32 is disposed in the paint roller cleaner 10 by securing an end portion 34 of the paint roller cover 30 to the idler 24 while inserting another portion 36 of the paint roller frame 32 in the slot 26. As understood by those of ordinary skill in the applicable arts as used herein throughout, a paint roller cover 30 (or roller cover) includes a hollow cylinder to which a nap (made of sheep's hide or of a synthetic material) is attached to, the nap being configured to hold the paint. The thickness of the nap, such as ¼″, ⅜″, ½″, ¾″, etc., is typically used to specify a given paint roller cover. Finally, the paint roller 32 (or roller frame) is the part that a user holds onto while painting.

Pressurized cleaning fluid supplied through the inlet 16 is discharged through the nozzle 18 onto the paint roller cover 30, causing it to rotate around the paint roller frame 32 with minimum friction while the position of the paint roller cover 30 is constrained by the idler 24 during the cleaning process. One of the advantageous features of the idler 24 is that, with the proper number of arms, the idler 24 simplifies the insertion of the paint roller cover into the cleaning device 10 and maintains the alignment of the paint roller cover during the cleaning, while maintaining a portion of the cover exposed to the cleaning fluid jet. In one embodiment, the idler 24 comprises 8 arms, although the number of arms is not a limiting feature of the subject matter disclosed herein. Used cleaning fluid is then discharged from the paint roller cleaner 10 through the outlet 20, which can be easily directed by the user manipulation of the handle 14 of the paint roller cleaner 10 over, for example, a bucket, a drain, or a sink.

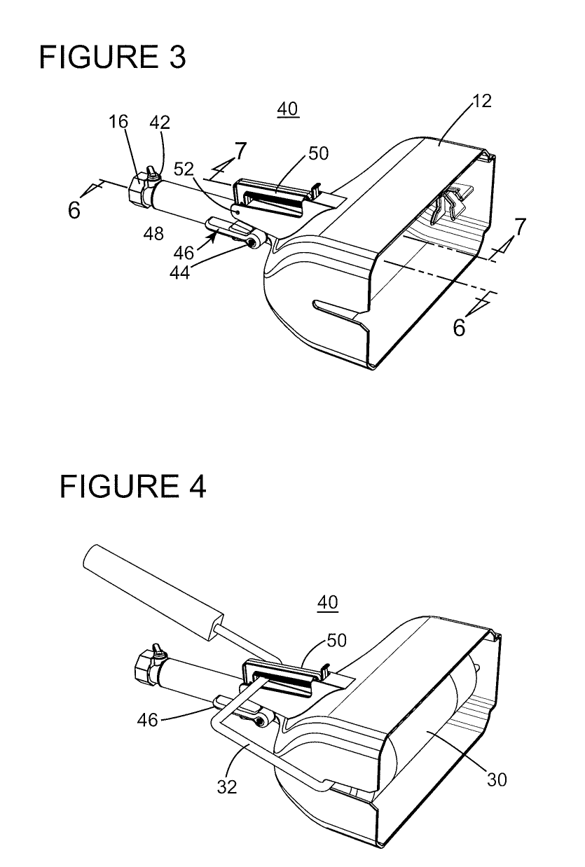

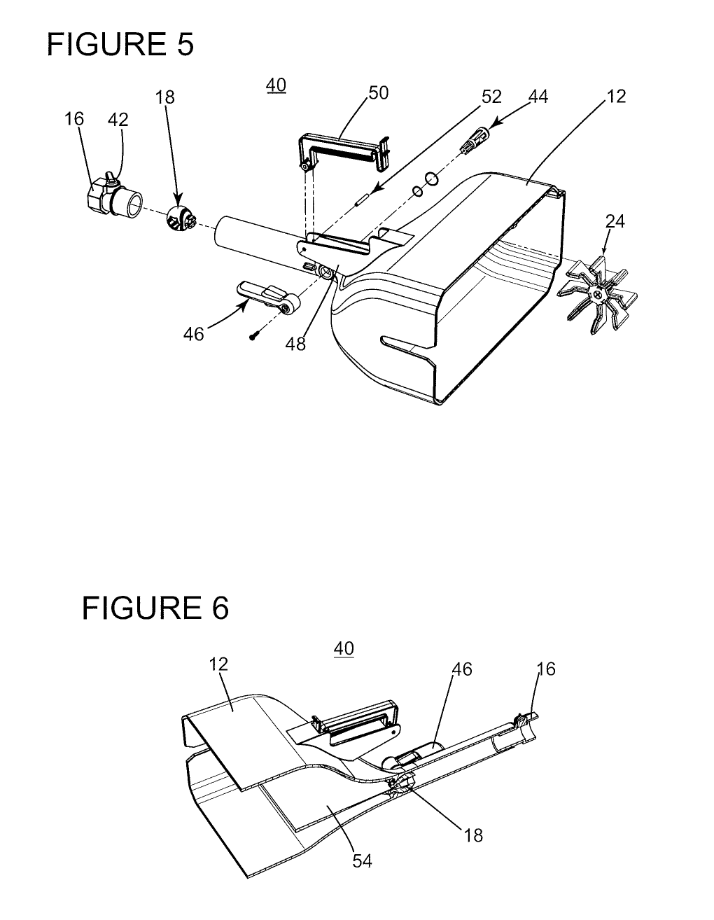

FIG. 3 illustrates a paint roller cleaner 40 according to another embodiment of the subject matter disclosed while FIG. 4 illustrates the paint roller cleaner 40 charged with a paint roller frame 32 and a paint roller cover 30 to be cleaned. In the embodiment of FIG. 3, the adapter 16 further includes a shut-off valve 42 to allow the flow of cleaning fluid to be turned on or off. Attachment of the adapter 16 with or without the cleaning-fluid-inlet shut-off valve 42 to the housing 12 may be accomplished, for example, but not as a limitation, by solvent bonding, ultrasonic welding, spin welding, tapered pipe threads that are self-sealing or include a gasket or alternate sealing method, straight threads with gasket or alternate sealing method, press-fit with or without crush ribs and with or without a gasket or alternate sealing method, snapped into place with gasket or alternate sealing method, screwed into place with gasket or alternate sealing method, or clamped into place with gasket or alternate sealing method, to name just a few examples. Alternately, rather than being a separate sub-assembly, the shut-off valve 42 may be made an integral feature of the housing 12. The shut-off valve 42 could be any device with the function of allowing the user to turn the supply of cleaning fluid on, off, or, optionally, to any state there between. Examples of shut-off valves include, but are not limited to, a ball valve, a butterfly valve, a ceramic disc valve, a choke valve, a diaphragm valve, a gate valve, a globe valve, a knife valve, a needle valve, a pinch valve, a piston valve, a plug valve, or a poppet valve. The nozzle 18 (not shown in FIG. 3), being mounted to an adjustment shaft 44 is movable by manipulation of a spray nozzle lever 46 connected to the adjustment shaft 44. In addition, the housing 12 further includes a mounting bracket 48 to which a roller frame clamp 50 is pivotally mounted using, for example, a clamp pin 52. In use, as shown in FIG. 4, the paint roller frame 32 is further kept in position by the roller frame clamp 50 while the point of impingement of the cleaning fluid spray is further controlled by rotation of the nozzle 18 (not shown in FIGS. 3 and 4) by manipulation of the spray nozzle lever 46 by the user. FIG. 5 shows an exploded view of the paint roller cleaner 40 of FIG. 3, illustrating the interrelationship of the various parts as just explained and including an illustration of the nozzle 18 not shown in FIGS. 3 and 4.

The ability to control the spray pattern in some embodiments is illustrated in FIG. 6, where a sectional view taken along line A-A of FIG. 3 is illustrated. By appropriately selecting the spray nozzle 18 and/or changing the angular position of the nozzle 18 by manipulation of the spray nozzle lever 46, a spray pattern 54 can be adjusted so as to cause the spray of cleaning fluid to impinge the paint roller cover at varying angles, thus allowing the penetration depth of the cleaning fluid into the nap and the rotational speed of the roller cover to be controlled.

Various advantageous embodiments of the spray nozzle 18 are within the scope of the subject matter disclosed. Those include, as an example, but not as a limitation, a spray nozzle that is adjustable within a given angle range, a spray nozzle that forms a dynamic seal with the housing 12, and a spray nozzle that alternately forms a static seal with the adapter 16 via a flexible tube which allows the spray nozzle to rotate, thus eliminating or reducing the need for a seal between the spray nozzle 18 and the housing 12.

In an alternative embodiment the spray nozzle 18 is fixed. In such embodiments, the spray nozzle may be fixed at an angle determined to provide a tradeoff between cleaning fluid penetration depth into the nap and/or the paint roller cover rotational speed. Ways to assemble the nozzle 18 into the housing 12 include, but are not limited to, molding the same as part of housing or a separate part that is insert-molded or otherwise attached to the housing 12. Keeping the nozzle as a separate part from the housing allows for the use of a harder material with a greater wear resistance versus a plastic that may be used for the housing. In embodiments having a fixed spray nozzle configuration, the same may be attached directly to the adapter 16 via a flexible tube or a rigid pipe.

In other embodiments, the spray nozzle is adjustable within a given number of settings within a given angle range. Example settings may include, but not be limited to, a deep-clean, a standard-clean, or a spin-dry setting. In other embodiments having an adjustable spray configuration, the spray nozzle may be adjusted in any position within a given angle range and may further function as an on/off valve when rotated to an angle largely perpendicular to the flow direction of the cleaning fluid. In addition, in other embodiments, the spray nozzle is continuously adjustable between a first position in which the spray jet is directed towards the center of the roller cover (a position for deep cleaning) and a second position in which the spray jet is directed towards a near-tangent line to the edge of the roller cover or the nap (a position to spin dry the roller cover). Another advantageous feature of having an adjustable spray is that the position of the spray jet may be adjusted depending on the nap thickness of the paint roller to be cleaned. Fixed or adjustable nozzles may be constructed of metal (stainless steel, steel, brass, copper, zinc, aluminum), ceramic, plastic, any combination of metal, ceramic, and/or plastic, or any other material or combination of materials that provides the desired wear-resistance, smooth surfaces, toughness, hardness, ease of manufacturing, low cost, high strength, bondability, chemical resistance, weather resistance, temperature resistance, and/or any other desired material properties.

In embodiments using either a fixed or adjustable spray nozzle configuration, two or more spray nozzles could be used to direct spray more uniformly across the length of the roller cover relative to that achieved with a single spray nozzle. The improvements in spray uniformity could include, but not be limited to: a spray trajectory with less angular variance across the length of the roller cover, and increased uniformity in the volumetric flow rate of cleaning fluid and/or spray velocity along the entire length of the paint roller cover or portions thereof.

In another embodiment, a slit/blade-type nozzle could be used to direct spray more uniformly across the length of the roller cover relative to that achieved with one or more fan-type spray nozzles. The improvements in spray uniformity along the entire length of the paint roller cover or a portion thereof could include, but not be limited to: a more constant spray trajectory angle, a more constant volumetric flow rate of cleaning fluid, and/or a more constant spray velocity.

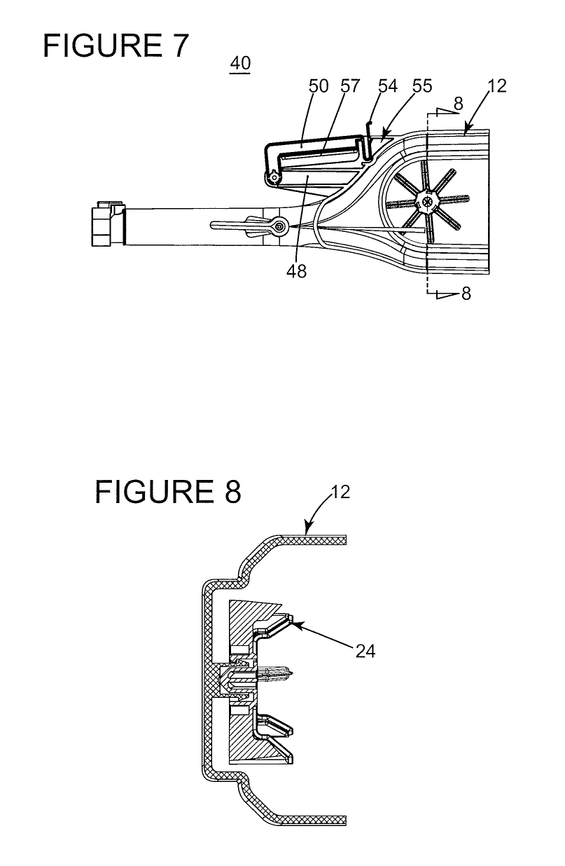

Further details of one embodiment of the roller frame clamp 50 is illustrated in FIG. 7, which shows a sectional view taken along line B-B of FIG. 3. As shown, an end portion of the roller frame clamp 50 may include a flexible portion 54 that snaps closed against a protrusion 55 extending from the mounting brackets 48 or from another portion of the housing 12. In addition, a complaint element 57 may be provided to bias the paint roller frame against the clamp 50 once the same is snapped in place. In use, the compliant element 57 (made of an elastomer material in some embodiments) is configured to apply a compressive load to the roller frame, to conform to the shape of the roller frame, and to increase friction between the roller clamp and the roller frame, thus helping the clamp to hold the roller frame more securely during cleaning. In embodiments in which the compliant element 57 is made of an elastomer material, methods by which the elastomer material may be bonded with the clamp 50 could include, but not be limited to: the elastomer is over-molded onto the clamp 50, the elastomer is insert-molded into the clamp 50 part, the elastomer is taped or solvent bonded onto the clamp 50, the elastomer is screwed to the clamp 50, the elastomer is attached to the clamp with integral rat-tails, or other attachment/bonding methods.

In one embodiment, as shown in FIG. 8 (wherein a side view along line C-C of FIG. 7 is illustrated), the mounting of the idler 24 to the housing 12 is made simpler by snapping the same into place with the provision of an optimized bearing surface configured to balance wear and friction (i.e., the provision of additional contact surface area between the idler and the housing could slow the rate that the idler tip decreases in length, thereby increasing idler life. However, on the other hand, the provisional of additional surface area would increase friction between these two surfaces).

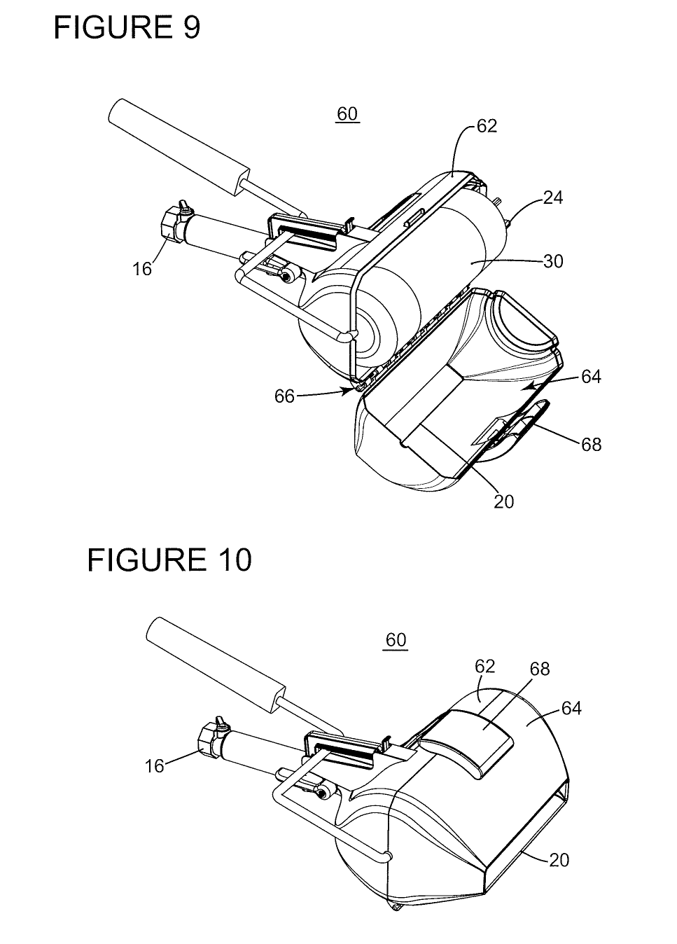

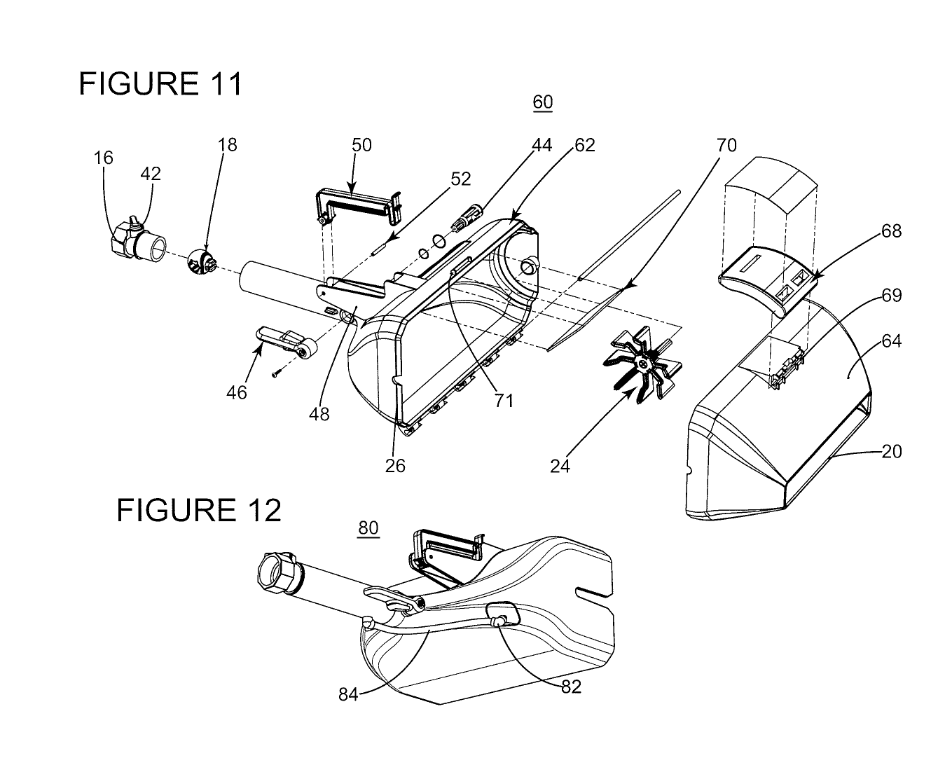

Another exemplary embodiment of a paint roller cleaner 60 according to the subject matter disclosed herein is illustrated in FIGS. 9, 10, and 11. As shown, the housing comprises two portions. A first portion 62 containing the nozzle 18 (shown in FIG. 11) and the adapter 16 and a second portion 64 that comprises the outlet 20. In the embodiment illustrated, the second portion 64 is connected to the first portion 62 via a hinge 66 that allows the paint roller cleaner 60 to be open when loading a paint roller 30 to be cleaned (or removing the same after the cleaning is done) or to be closed during operation and/or storage. A snap lock 68 may be used to insure closure of the housing when cleaning a paint roller or storing the cleaning device. In addition, as shown in the exploded view in FIG. 11, the first portion 62 of the housing also includes a window 70, thus allowing a user to more easily monitor the cleaning process. As also shown in the embodiment illustrated in FIGS. 9-11, the shape of the second portion 64 containing the outlet 20 may be further streamlined so as to better assist in the handling of the cleaning fluid discharged from the cleaning device when in use. In the context of this application, the term “streamlined” is used broadly, meaning that the second portion 64 is shaped so as to minimize flow resistance and to direct cleaning fluid discharge to the smallest cross-sectional area possible so as to improve the speed of fluid being discharged while at the same time assisting to control the flow of cleaning fluid through the device.

As illustrated herein, in embodiments that include a housing having two portions, the first portion 62 of the housing may include the various mounting features as well as a bearing surface for the idler 24. However, those of ordinary skill in the applicable arts will appreciate, after consideration of the subject matter disclosed, that the second portion 64 of the housing could alternately provide these mounting features and bearing surface and/or the mounting features and bearing surface for the idler 24 could alternately be provided by one or more additional parts which would attach to either housing portions 62 or 64. Although illustrated herein otherwise, the housing second portion 64 may provide in other embodiments for a hinge mounting, roller frame clamping surfaces, and snap engagement. As already explained, the first portion 62 of the housing may provide for the window 70 for monitoring the cleaning process. Alternatively, the window 70 may also be provided in the portion 64 of the housing. In another embodiment, housing portions 62 and 64 may be made transparent such that no window is required. Finally, in embodiments that include a housing having two portions, a lap joint with or without an elastomeric gasket for sealing the two housing parts to each other during cleaning may be used. In these embodiments, such a lap joint could be replaced by a face seal that could be formed with or without an elastomeric gasket. For lap joints with inner and outer ribs, the same could be provided in either portions of the housing. That is, the outer rib of the lap joint may be provided in the first portion 62 and the inner rib on the second portion 64 or vice-versa.

As already explained, another advantageous feature of the housing 12 is that the notch 26 disposed thereon provides clearance for roller frame wire so as to position the roller frame during insertion and cleaning, thus establishing near-concentricity of the roller cover relative to the housing and idler parts. Comparing the slots 26 in FIGS. 1 and 11, it should be understood that various sizes of slots are within the subject matter disclosed, i.e., a long slot as illustrated in FIG. 1 or a short slot in the shape of a semi-circle as the one illustrated in FIG. 11.

Advantageous functionality aspects of the second housing portion 64 include, but are not limited to: restricting the discharge of cleaning fluid to a defined outlet region, thereby enabling the waste cleaning fluid to be better directed away from the user and to a desired location such as into a bucket, onto a lawn, or into a drain. Alternately, the second housing portion 64 could be eliminated by extending the outlet region of the first housing portion 62 to provide the function just described for the housing portion 64. The housing portion 64 is also configured to receive a snap mounting feature 69, but alternately the snap 68 could be mounted to the housing portion 62; to provide hinge features for rotatable attachment of first and second housing portions 62 and 64; and to provide a notch to constrain and allow clearance for a roller frame wire. As also illustrated in FIG. 11, the first portion 62 of the housing may also incorporate a protrusion 71 to allow the snap 68 to properly lock the two portions of the housing together.

FIG. 12 illustrates a paint roller cleaner 80 according to yet another embodiment of the subject matter disclosed. As illustrated, the paint roller cleaner 80 includes an auxiliary nozzle 82 configured to better concentrate cleaning fluid to an end portion (or portions for embodiments having multiple auxiliary nozzles) of the paint roller cover being cleaned. By diverting cleaning fluid upstream of the main nozzle 18 to the end portion(s) of the paint roller cover, the auxiliary nozzle 82 will increase the cleaning effectiveness by assuring that sufficient cleaning fluid impinges onto the end portion(s) of the paint roller covers at an adequate angle normal thereto in order to assure an efficient and thorough cleaning process. As noted, a plurality of auxiliary nozzles 82 could be used on other embodiments, thus reducing and/or eliminating the need that a paint roller cover may need to be turned over or flipped once during cleaning. Furthermore, a plurality of auxiliary nozzles 82, positioned and oriented appropriately, may achieve the desired cleaning effect without the need for one or more adjustable spray nozzles. As understood by those of ordinary skill, a preferred location for the auxiliary nozzle 82 may not exist, i.e., it can be disposed in either side of the housing 12 with respect to the position of the paint roller cover being cleaned. In some embodiments, the auxiliary nozzle 82 could be molded as part of the housing 12. Alternatively, the auxiliary spray nozzle 82 could be heat-staked, solvent-bonded, ultrasonic-welded, screwed, pressed, taped, or snapped into the housing. The auxiliary spray nozzle 82 (or the main spray nozzle for that matter) could be made from any combination of plastic, ceramic, metal, or any other material, and could be made by injection molding (with or without post machining), die-casting (with or without post machining), machining only, extruding and machining, or partially crimping a tube or similar element to form a partially hollow shape. The auxiliary nozzle 82 may be made adjustable or fixed. In embodiments in which this element is adjustable, the adjustment may occur with or be separate from the adjustment of the main spray nozzle. Also, in embodiments in which the main nozzle is fixed, the auxiliary spray nozzle 82 may be adjustable.

In embodiments having the auxiliary nozzle 82, a cleaning fluid connection could include, but not be limited to, an internal cleaning fluid passage disposed in the housing, which could be a separate part (rigid or flexible) or could be molded as part of the housing with gas or fluid-assisted injection molding or by other means. In the embodiment shown in FIG. 12, an external cleaning fluid passage 84 is illustrated. Similar to embodiments having the noted internal cleaning passages, such external cleaning fluid passages may be a separate part (rigid or flexible) or may be molded as part of the housing with gas or fluid-assisted injection molding or by other means. In such embodiments, the cleaning fluid connection could further be combined with the auxiliary nozzle as a single part, combined with the auxiliary nozzle as a sub-assembly, or could be a stand-alone part. Finally, the auxiliary spray nozzle 82 could contain one or more orifices and could produce a spray pattern having narrow or wide angle, flat fan, off-center flat, conical, square, solid stream, or of any other geometry.

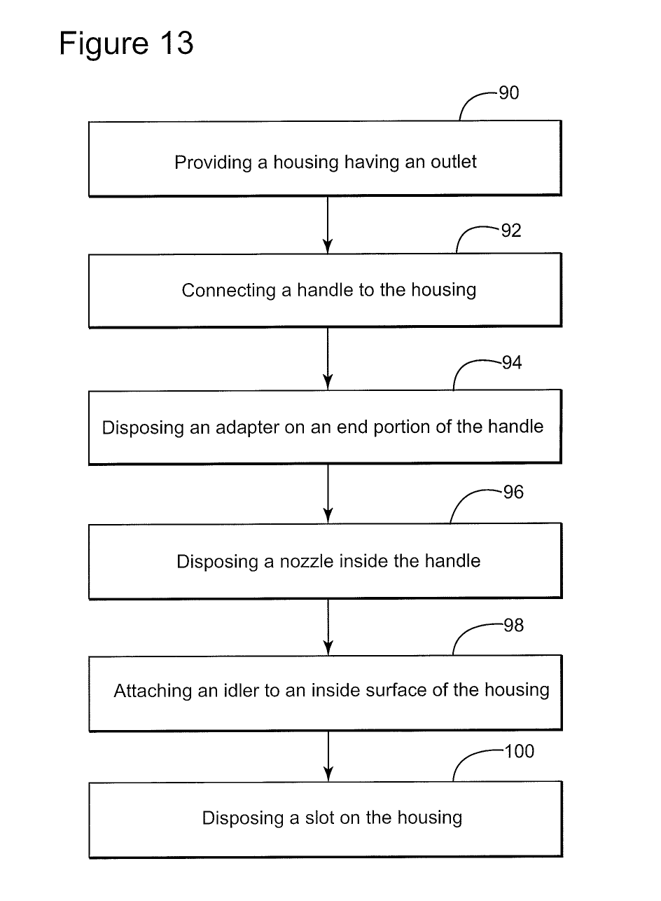

According to another exemplary embodiment, a process or method for cleaning a paint roller cover is disclosed as illustrated in the flowchart shown in FIG. 13. As this process is intended to be as complete as possible, it is noted that not all the steps need to be performed for cleaning a paint roller cover. In other words, some steps to be described next may be optional.

As shown in FIG. 13, the method for cleaning a paint roller includes the steps of providing a housing having an outlet configured to discharge a cleaning fluid at 90; connecting a handle to the housing at 92; disposing an adapter on an end portion of the handle at 94, the adapter being configured to connect the paint roller cleaner to a supply of the cleaning fluid under pressure; disposing a nozzle inside the handle at step 96, the nozzle being configured to generate a cleaning fluid jet; attaching an idler to an inside surface of the housing at 98; and disposing a slot on the housing on a location substantially opposite to the location of the inside surface of the housing where the idler is attached at 100, wherein the idler is configured to support a paint roller cover of a paint roller to be cleaned, the slot is configured to receive a first portion of a frame of the paint roller so as to dispose the paint roller cover substantially in front of the cleaning fluid jet.

Additional steps for the above-summarized method may also include inserting an end portion of the paint roller cover into the idler; inserting the first portion of the frame into the slot; and spraying the paint roller cover with the cleaning fluid jet; clamping a second portion of the frame to the housing before the spraying; locking a first portion of the housing to a second portion of the housing after the inserting of the first portion of the frame into the slot, the first and second portions of the housing being pivotally connected to each other; and spraying one of the edges of the paint roller cover with an auxiliary nozzle mounted on the housing.

In the detailed description of the exemplary embodiments, numerous specific details are set forth in order to provide a comprehensive understanding of the claimed invention. However, one skilled in the art would understand that various embodiments may be practiced without such specific details.

The disclosed exemplary embodiments provide apparatuses, systems and methods for cleaning paint roller covers. It should be understood that this description is not intended to limit the invention. On the contrary, the exemplary embodiments are intended to cover alternatives, modifications and equivalents, which are included in the spirit and scope of the invention as defined by the appended claims.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A paint roller cleaner, comprising:
a housing having an outlet configured to discharge a cleaning fluid from the paint roller cleaner;
an adapter disposed on an end portion of the housing, the adapter being configured to connect the paint roller cleaner to a supply of the cleaning fluid;
a nozzle disposed inside the housing, the nozzle being configured to generate a cleaning fluid jet;
an idler attached to an inside surface of the housing; and
a slot disposed on the housing on a location substantially opposite to the location of the inside surface of the housing where the idler is attached, wherein the idler is configured to support a paint roller cover to be cleaned and the slot is configured to receive a first portion of a paint roller frame configured to support the paint roller cover so as to dispose the paint roller cover substantially in front of the cleaning fluid jet.

2. The paint roller cleaner according to claim 1, further comprising:
A handle attached to the housing; and
a valve disposed on the handle, the valve being configured to control the flow of cleaning fluid.

3. The paint roller cleaner according to claim 1, further comprising:
a lever connected to the nozzle, the lever being configured to change a position of the cleaning fluid jet.

4. The paint roller cleaner according to claim 1, further comprising:
a clamp disposed on an outside surface of the housing, the clamp being configured to hold a second portion of the paint roller frame.

5. The paint roller cleaner according to claim 1, wherein the housing further comprises a first portion and a second portion pivotally mounted to each other, the outlet being disposed on the second portion of the housing.

6. The paint roller cleaner according to claim 5, further comprising:
a locking mechanism disposed on the second portion of the housing; and
a protrusion disposed on the first portion of the housing, wherein the locking mechanism is configured to engage with the protrusion to close the first and second portions of the housing.

7. The paint roller cleaner according to claim 1, further comprising:
a transparent window disposed on the housing, wherein the transparent window is configured to allow a user to monitor the cleaning of the paint roller in the paint roller cleaner.

8. The paint roller cleaner according to claim 1, further comprising:
an auxiliary nozzle disposed on the housing, wherein the auxiliary nozzle is configured to generate an auxiliary jet of cleaning fluid to clean one of the ends of the paint roller cover.

9. The paint roller cleaner according to claim 8, further comprising:
a cleaning fluid flow passage connecting the auxiliary nozzle to a supply of cleaning fluid.

10. A paint roller cleaner, comprising:
a housing having an outlet configured to discharge a cleaning fluid from the paint roller cleaner;
a handle connected to housing;
an adapter disposed on an end portion of the handle, the adapter being configured to connect the paint roller cleaner to a supply of the cleaning fluid;
a nozzle disposed inside the handle, the nozzle being configured to generate a cleaning fluid jet;
a lever connected to the nozzle, the lever being configured to change a position of the cleaning fluid jet;
an idler attached to an inside surface of the housing;
a valve disposed on the handle, the valve being configured to control the flow of cleaning fluid;
a clamp disposed on an outside surface of the housing, the clamp being configured to hold a first portion of a paint roller frame configured to support the paint roller cover; and
a slot disposed on the housing on a location substantially opposite to the location of the inside surface of the housing where the idler is attached, wherein the idler is configured to support a paint roller cover to be cleaned and the slot is configured to receive a second portion of the paint roller frame so as to dispose the paint roller cover substantially in front of the cleaning fluid jet.

11. The paint roller cleaner according to claim 10, wherein the housing further comprises a first portion and a second portion pivotally mounted to each other, the outlet of the housing being disposed on the second portion of the housing and a transparent window disposed on the housing, wherein the transparent window is configured to allow a user to monitor the cleaning of the paint roller in the paint roller cleaner.

12. The paint roller cleaner according to claim 10, further comprising:
an auxiliary nozzle disposed on the housing, wherein the auxiliary nozzle is configured to generate an auxiliary jet of cleaning fluid to clean one of the ends of the paint roller cover.

13. The paint roller cleaner according to claim 12, wherein the auxiliary nozzle is adjustable.

14. The paint roller cleaner according to claim 10, further comprising:
A plurality of auxiliary nozzles disposed on the housing, wherein the plurality of auxiliary nozzles is configured to generate auxiliary jets of cleaning fluid to clean the ends of the paint roller cover.

15. The paint roller cleaner according to claim 12, further comprising:
a cleaning fluid flow passage connecting the auxiliary nozzle to a supply of cleaning fluid to the nozzle.

16. A method of cleaning a paint roller, the method comprising:
providing a housing having an outlet configured to discharge a cleaning fluid;
connecting a handle to the housing;
disposing an adapter on an end portion of the handle, the adapter being configured to connect the paint roller cleaner to a supply of the cleaning fluid;
disposing a nozzle inside the handle, the nozzle being configured to generate a cleaning fluid jet;
attaching an idler to an inside surface of the housing; and
disposing a slot on the housing on a location substantially opposite to the location of the inside surface of the housing where the idler is attached, wherein the idler is configured to support a paint roller cover to be cleaned and the slot is configured to receive a first portion of a paint roller frame configured to support the paint roller so as to dispose the paint roller cover substantially in front of the cleaning fluid jet.

17. The method according to claim 16, further comprising:
inserting an end portion of the paint roller cover into the idler;
inserting the first portion of the paint roller frame into the slot; and
spraying the paint roller cover with the cleaning fluid jet.

18. The method according to claim 17, further comprising:
clamping a second portion of the frame to the housing before the spraying.

19. The method according to claim 17, further comprising:
locking a first portion of the housing to a second portion of the housing after the inserting of the first portion of the frame into the slot, the first and second portions of the housing being pivotally connected to each other.

20. The paint roller cleaner according to claim 17, further comprising:
spraying one of the edges of the paint roller cover with an auxiliary nozzle mounted on the housing.
